(19) United States
(12) Patent Application Publication
(10) Pub. No.: US 2020/0173100 A1
(43) Pub. Date: Jun. 4, 2020

(54) CARBON FIBER TOW WITH IMPROVED PROCESSABILITY

(71) Applicant: SABIC Global Technologies B.V., Bergen op Zoom (NL)

(72) Inventor: Reema Sinha, Bangalore (IN)

(21) Appl. No.: 16/624,025

(22) PCT Filed: Aug. 1, 2018
(86) PCT No.: PCT/IB2018/055798

§ 371 Date: Dec. 18, 2019

(30) Foreign Application Priority Data
Aug. 1, 2017 (IN) 201741027230

(51) Int. Cl. D06M 15/53; D06M 10/10; C08J 5/06

(52) U.S. Cl. CPC D06M 15/53; D06M 2101/40; C08J 5/06; D06M 10/10

(57) ABSTRACT

In one embodiment, a sized carbon fiber tow can comprise: an unsized carbon fiber tow sized with a sizing agent; wherein the sized carbon fiber tow has: a) a fuzz count of less than 8 counts/20 meters; b) a sizing content of at least 0.4 wt % of the unsized carbon fiber tow; and c) drapability less than 5.5 cm. A method of preparing a sized carbon fiber tow, comprising: spreading an unsized carbon fiber tow having a surface energy of at least 70 mJ/m², over a spreader unit at a throughput line speed of at least 3 meter/minute and forming spread carbon fibers; sizing the spread carbon fibers in a sizing bath at a throughput line speed of at least 3 meter/minute and forming sized carbon fibers; and drying the sized carbon fibers and forming the sized carbon fiber tow.

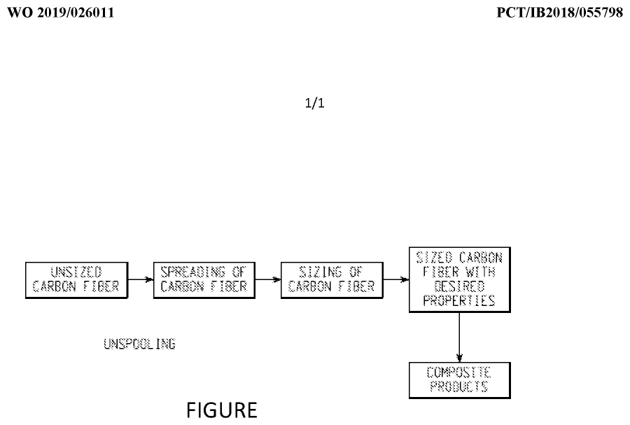

### CROSS REFERENCE TO RELATED APPLICATION

The present application is an international application filed claiming priority to India Application No. 2017/41027230, filed Aug. 1, 2017, which is incorporated herein by reference.

### FIELD OF INVENTION

The present disclosure generally relates to a sized carbon fiber tow and more particularly to sized carbon fiber tow having improved processability, sizing content and drapability, and methods of preparing such sized carbon fiber tow.

### BACKGROUND OF THE INVENTION

Sized carbon fiber tow are widely used as intermediate materials for making woven fabrics, pre-pregs, unidirectional tapes and other composite based materials. Carbon fibers as reinforcing fibers in composites have inherent drawbacks such as low ductility, high brittleness, and low polymer resin wettability.

Another drawback associated with the use of carbon fibers as reinforcing fibers is fuzz or fiber breakage, which occurs while sizing or processing carbon fibers on a continuous production line. The fuzz content on the carbon fiber surface, affects processing and handling of carbon fibers as well as mechanical integrity of any reinforced composite, using such carbon fibers. Fuzz content on carbon fibers may affect gloss and aesthetic appearance of composite products. In addition, carbon fibers are generally electrically conductive in nature, the fuzz generated can cause short circuit at electrical lines during production, and processing of carbon fiber based products. With recent developments focusing on automated and higher throughput processes for sizing, fuzz generation and fiber breakage is a serious hindrance on product quality and overall process productivity.

In order to improve upon these drawbacks, Wang et.al have reported in their publication (“Effects of surface treatment of carbon fiber: Tensile Property, Surface Characteristics, and Bonding to Epoxy” DOI:10.1002/pc.23489,Polymer Composites) the use of electrolytic surface treatment along with a sizing treatment to enhance inter-laminar shear strength (ILSS) and improve matrix adhesion or wettability. The electrolytic surface treatment of the carbon fibers may be carried out by any of the methods disclosed in the prior art to generate the required surface energy for resin wettability. Such methods have been claimed for example under the U.S. Pat. No. 4,234,398 and have also been reported by Wang et al. in their publication. However, in both these references the fuzz content on the surface treated carbon fiber will remain a problem for further processing and handling of carbon fiber.

Under the US patent application 2013/253096, Kibayashi et al. (Published on Sep. 26, 2013) discloses a sized carbon fiber with a specific sizing content. However, the fuzz content associated with such a sized carbon fiber product will not completely mitigate all the drawbacks and product quality risks associated with fuzz. Further, as discussed in the Kibayashi patent, the process of sizing and accordingly fuzz measurement, involves the use of four rollers with a relatively low wrap angle. The low wrap angle for sizing would result in lower spreadability, resulting in low sizing content on the carbon fibers, which may affect mechanical properties of composites using such carbon fibers.

Further, as required by the industry, the throughput line speed used for processing/sizing the carbon fibers, should be as high as possible for ensuring excellent productivity and lowering of production cost. However, at high line speed carbon fibers produced have increased fuzz or fiber breakage due to abrasion at higher speed of the carbon fibers with the sizing equipment. The processing of sized carbon fibers have also been generally described by Miller et.al under the U.S. Pat. No. 5,369,146 with the need of lowering fuzz and yarn breakage. However, the '146 patent does not specifically address problems related to productivity and drape.

Thus there is a continued need for developing a sized carbon fiber tow which has substantially no fuzz, a good sizing content while still being produced at high productivity and lowered production cost.

### SUMMARY OF THE INVENTION

Disclosed herein are carbon fiber tows, methods for making carbon fiber tows, and the use of those carbon fiber tows.

In one embodiment, a sized carbon fiber tow can comprise: an unsized carbon fiber tow sized with a sizing agent; wherein the sized carbon fiber tow has: a) a fuzz count of less than 8 counts/20 meters; b) a sizing content of at least 0.4 wt % of the unsized carbon fiber tow; and c) drapability less than 5.5 cm.

In one embodiment, a method of preparing a sized carbon fiber tow can comprise: spreading an unsized carbon fiber tow having a surface energy of at least 70 mJ/m², over a spreader unit at a throughput line speed of at least 3 meter/minute and forming spread carbon fibers; sizing the spread carbon fibers in a sizing bath at a throughput line speed of at least 3 meter/minute and forming sized carbon fibers; and drying the sized carbon fibers and forming the sized carbon fiber tow.

### BRIEF DESCRIPTION OF THE FIGURE

The accompanying FIGURE, constitutes a part of the specification and is incorporated herein to explain the principles of the invention.

FIGURE is an illustration of the overall process flow diagram for the production of sized carbon fiber tow sizing.

### DETAILED DESCRIPTION OF THE INVENTION

It was desirable to provide a sized carbon fiber tow, which can be produced at high throughput line speed with excellent productivity and has excellent productivity on account of having low fuzz or fiber breakage.

It was also desirable to develop a sized carbon fiber tow having high sizing content and low drapability.

In order to accomplish the objectives of the present invention, the inventors unexpectedly found that, unsized carbon fiber tow having a surface energy of at least 70 milliJoules per square meter (mJ/m²) when drawn at a throughput line speed of at least 3 meter/minute, results in a sized carbon fiber tow having excellent sizing content, drapability and low fuzz content. More particularly, the present invention relates to a carbon fiber tow having a fuzz count lower than 8 counts/20 meters, a sizing content of at least 0.4 wt % and drapability less than 5.5 centimeters (cm). The present invention further discloses methods of producing such sized carbon fiber tow produced at throughput line speed of at least 3 meter/minute.

The present disclosure relates to a sized carbon fiber tow having improved processability, sizing content and drapability. Particularly the sized carbon fiber tow developed in accordance with the present invention is substantially free of fuzz or fiber breakage even when produced at high throughput line speed. The present invention further discloses methods of preparing such a sized carbon fiber tow with excellent productivity and reduced cost of production. The sized carbon fiber tow of the present invention is suitable for making unidirectional tapes, composites and woven fabrics.

In accordance with one aspect of the present invention, the inventors unexpectedly found that a sized carbon fiber tow having excellent sizing content and drape property, can be produced from an unsized carbon fiber tow having sufficiently high surface energy when sized at a high throughput line speed without generating any fuzz or fiber breakage. Particularly, the present invention relates to a sized carbon fiber tow comprising a sizing agent on an unsized carbon fiber tow having a surface energy of at least 70 mJ/m² and the sized carbon fiber tow is characterized by having a) a fuzz count of less than 8 counts/20 meters of the sized carbon fiber tow b) a sizing content of at least 0.4 wt % of the unsized carbon fiber tow c) drapability less than 5.5 centimeter (cm).

The FIGURE is an illustration of a typical process for the production of sized carbon fiber tow. The sizing of unsized carbon fiber tow is crucial for enhancing the resin wettability as well as improving the abrasive resistance of carbon fibers. Sized carbon fibers have enhanced inter-laminar shear strength (ILSS), resulting in improved fiber-matrix adhesion and thereby enhancing the desired properties of composites. Further, a sized carbon fiber tow has improved processability by way of improved fiber bundle cohesion, spreadability, resistance to fuzz formation, fiber smoothness, abrasion resistance, and windability. For ensuring a superior quality of sized carbon fibers, the sizing content needs to be high while ensuring that drapability and the fuzz content remains low.

The sizing of the carbon fibers can be effected through a sizing operation involving a sizing line operated at a high throughput line speed of at least 3 meter/min. Particularly, the sizing process involves a method of preparing a sized carbon fiber tow comprising a process of spreading an unsized carbon fiber tow having a surface energy of at least 70 mJ/m²over a spreader unit at a throughput line speed of at least 3 meter/minute to form spread carbon fibers. The spread carbon fibers are subsequently sized in a sizing bath at a throughput line speed of at least 3 meter/minute to form sized carbon fibers. The sized carbon fibers are then dried over a heater to form the sized carbon fiber tow.

In some embodiments of the present invention, the sizing operation may be initiated by unspooling a spool of unsized surface treated carbon fiber tow procured from a supplier. In some other embodiments, the unsized carbon fiber tow is used directly by integrating the sizing line with a pre-sizing treatment unit without winding or unspooling the carbon fibers.

In some embodiments of the present invention, a spool of unsized surface-treated carbon fiber tow is unspooled from a bobbin to generate unspooled carbon fiber tow, which is set on the sizing line for the sizing operation. The unsized surface-treated carbon fiber tow have a carbon fiber filament number from 1000 (1K) to 50000 (50K) filaments. The carbon fiber filaments have a diameter in a range of 1 to 12 micrometers (μm), preferably in the range of 3 to 10 μm, and most preferably in the range of 5 to 8 μm.

For example, a carbon fiber tow having filament number of 12K may be used. The carbon fiber filaments are derived from polyacrylonitrile (PAN) although other sources such as pitch, rayon, polyesters, polyamides, may also be used as a source for the carbon fiber filaments.

The unsized carbon fiber tow may be surface treated prior to initiating the sizing process. Surface treatment or surface functionalization of the carbon fiber filaments introduces polar functional groups on the carbon fiber surface, which enhances the surface energy of the carbon fibers, which in turn is crucial for improving the adhesion or wettability with resin matrix in composites. However, excess surface functionalization of the unsized carbon fiber tow or a carbon fiber tow having very high surface energy may result in low tensile modulus and strength, affecting the mechanical integrity of the carbon fiber.

The surface energy of the unsized carbon fiber tow can be at least 70 mJ/m². In some embodiments of the present invention the unsized carbon fiber has a surface energy in a range of 70 mJ/m² to 90 mJ/m², preferably in the range of 71 mJ/m² to 78 mJ/m² and most preferably in the range of 72 mJ/m² to 76 mJ/m². Surface energy may be measured by any of the techniques known in the art and one such technique involves injecting n-alkanes and polar probes at specific fractional surface coverages, to measure the retention time and correlate the retention time to the dispersive surface energy and specific free energy to arrive at the reported surface energy values.

The unsized surface treated carbon fiber tow after unspooling or the unspooled carbon fibers, can be drawn towards a spreader unit on the sizing line, drawn at a specific throughput line speed to generate spread carbon fibers. The spreading unit can comprise at least five rollers, preferably at least six rollers, and most preferably at least seven rollers. The rollers may be made of a plastic or a metal based material. The metal based rollers if used, may be hard chrome plated with mirror finish. The carbon fiber path in the spreading unit has a total wrapping angle of at least 500 degrees, and preferably at least 506 degrees. In comparison, to the US patent application 2013/253096 by Kibayashi et al. the present arrangement of the spreader unit, will ensure an improved spreading and improved sizing and resin impregnation. The sizing equipment has a tension controlled creel system from which the unsized carbon fiber tow is dispatched and passed over to the spreader unit for spreading the carbon fiber tow. The sizing equipment tension may be kept at a range of 0.5 Newtons (N) to 5 N for drawing the carbon fibers. Preferably, the sizing equipment tension is kept at 0.75 to 2 N, e.g., 1N.

One of the ways of achieving an optimum level of sizing on the sized carbon fiber, is to spread the unsized carbon fiber tow to an optimum level of spreadability prior to applying a sizing agent. An optimum level of spreadability ensures excellent resin impregnation resulting in improved resistance to delamination and improved mechanical properties in composite products. Spreadability of the carbon fiber may be calculated by using Formula I:

Spreadability (%)=((S_{b}−Sₐ)/(Sₐ))×100 (Formula I)

wherein, S_{b}=final width of carbon fiber tow emerging from the spreader unit prior to entering sizing bath; Sₐ=width of the unsized carbon fiber tow prior to entering the spreader unit.

In general, it is known that the sizing operation needs to be operated within a specific range of throughput line speed for ensuring excellent sizing content and process productivity. At high throughput line speed, the overall sizing operation will have excellent process productivity and sizing content. However, the throughput line speed cannot be increased beyond a limit, as at very high throughput line speed, residence time of the carbon fibers in the sizing bath and the contact time of the fibers with the sizing agent, will be low enough to adversely affect the sizing quality. Further, at a higher throughput line speed, the fuzz generation on the carbon fibers may increase due to enhanced abrasion between the carbon fibers and the rollers. Conversely, it is evident that at low throughput speed, the fuzz generation will be low due to lower abrasion. However, at such low throughput line speed, the overall productivity and economics of the sizing operation may be unviable for the commercial production of such carbon fiber tow.

In some embodiments of the present invention, the spreading and sizing of the carbon fibers is conducted at a throughput line speed of at least 3 meter/minute, preferably at a range of 3.5 meter/minute to 10 meters/minute and most preferably at a range of 4 meters/minute to 8 meters/minute.

In some embodiments of the present invention, it is observed that when the spread carbon fibers are formed using a spreader unit operated at a high throughput line speed, the spreadability is ideal for achieving the optimum level of sizing content. This observation is also evidenced under Tables 2 and 4 of Example 1 and 2, which illustrates that in general, a higher throughput line speed enhances the sizing content with increased spreadability before attaining a maxima. However, it is also evident, that spreading the carbon fibers at a high throughput line speed using several rollers, the abrasion of the carbon fiber against the spreading rollers and/or sizing equipment will generate high fuzz content on the carbon fiber surface. At low throughput line speed, lower spreadability of the carbon fibers leads to lower sizing content.

In accordance with some embodiments of the present invention, the inventors surprisingly found that optimum spreadability of the carbon fiber tow sufficient to promote fiber matrix adhesion in composites, is achieved at relatively higher throughput line speed compared to conventionally used line speeds. The spreadability value of the carbon fibers when measured in accordance with Formula I is at least 150%, preferably in a range of 155% to 220%, and most preferably in a range of 178% to 202%.

In some embodiments of the present invention, the spread carbon fibers from the spreader unit, are drawn to a sizing bath containing a slurry of sizing agent. The sizing bath may be maintained at ambient room temperature or at a temperature sufficient for sizing the spread carbon fibers and generating the sized carbon fibers. The sizing is carried out at a throughput line speed of at least 3 meter/minute, preferably, the sizing is carried out at a throughput line speed at a range of 3.5 meter/minute to 10 meter/minute, and most preferably sizing is carried out at a range of 4 meter/minute to 8 meter/minute. The throughput line speed as used for the purposes of producing the sized carbon fiber tow of this invention is higher compared to what is used generally in the industry. The sizing bath may contain sizing agent in an amount ranging from 1-5 wt % of the total solid content of the slurry.

The sizing agent can include at least one of the following polymers or resins selected from polyurethane, polypropylene, polyethylene, polycarbonate, polyetherimide, siloxane resins, polyketones, polysulfone, polyethersulfone, polyetheretherketone, polyetherketoneketone, polyphenylenesulfide, polyacrylates, polyvinylacetates, polyamide, polyesters, polyetherimide, polyamines, polyimides, epoxy resins, phenoxy resins, melamine resins, urea resins, polyamideimides, polyethersulfones, polyetheretherketones, polyetherketoneketones, polyphenylenesulfides and combinations thereof. In one embodiment of the present invention, polyurethane or phenoxy resins may preferably be used as sizing agent.

The sized carbon fibers can be subsequently passed through a nip roller to squeeze out any excess sizing agent on the carbon fiber surface before drying the sized carbon fibers in an oven to obtain the sized carbon fiber tow. It has been observed that the drying of the sized carbon fibers need to be conducted at an optimum temperature, at too low a temperature the drying is ineffective while at very high temperature the sizing on the carbon fiber tow may get degraded. The oven is maintained at a temperature range of 105° C. to 260° C., preferably in a range of 110° C. to 200° C., and most preferably in a range of 115° C. to 150° C. Optionally, the oven may include an Infra-red (IR) heater to supplement the drying operation.

In some embodiments of the present invention, the sized carbon fiber tow may subsequently, be winded in a spool to be transported to different locations for manufacturing composite articles or for fabrication. In some other embodiments, the sized carbon fiber tow may be directly passed to a production line for composite manufacturing.

The sizing agent used can be a thermosetting or a thermoplastic polymer depending on the polymer matrix used for making composites. The sizing agent can be selected to impart properties such as high heat resistance, resistance to delamination, enhanced wettability and mechanical reinforcement to the composites.

The content of sizing agent on the carbon fiber tow needs to be at an optimum level for the application of carbon fibers in composites, tapes or in woven fabrics. If the sizing content is too low, carbon fibers will have low thermodynamic wettability and low adhesion with a resin matrix. Further, low sizing content will compromise the abrasive resistance of the carbon fibers, which may result in fuzz generation while fabricating tapes or fabrics. On the other hand, a high sizing content will result in carbon fibers being stiff and affecting its drapability. Further, high sizing content results in voids, resulting in poor density and spreadability characteristics. In such instances, even low viscosity resins have experienced reduced impregnation leading to undesirable mechanical properties. In addition, from an environmental standpoint, at high sizing content, the possibility of harmful volatiles forming is significant and may invite regulatory restrictions on products using such sized carbon fibers. Inventors surprisingly found that the sized carbon fiber tow obtained has excellent sizing content, low drapability and is substantially free of fuzz.

The sizing content of the sized carbon fiber tow can be measured by ash test or solvent digestion technique (ASTM D2584) depending on the type of sizing agent used and can be calculated using Formula II as shown below:

Sizing content: The sizing content of the dried carbon fiber is measured using the formula:

Sizing content (%)=((w₁−w₀)/w₀)×100 (Formula II)

wherein, w₁=weight of sized carbon fiber tow; w₀=weight of unsized carbon fiber tow.

The sizing content or the amount of sizing on the sized carbon fiber tow is at least 0.4% by weight of the unsized carbon fiber tow. In some embodiments of the present invention the sizing content is in a range of 0.42% by weight to 1.2% by weight of the unsized carbon fiber tow, preferably in a range of 0.45% by weight to 1.1% by weight of the unsized carbon fiber tow, and most preferably in a range of 0.6% by weight to 0.9% by weight of the unsized carbon fiber tow.

The drapability of a sized carbon fiber is a critical parameter to assess the quality of the sized carbon fiber. The drapability value should be sufficiently low to ensure that the sized carbon fiber tow is flexible for further processing and fabrication especially while making weaved fabrics. Further drapability determines the winding of sized carbon fiber tow on bobbins or spool for further commercial application. If drapability of the sized carbon fiber tow is not sufficiently low, the winding of the sized fiber on bobbins or spools will be a impeded as the fibers would tend to get unwind which is not desirable.

In accordance with another aspect of the present invention, the drapability can be lower than 5.5 cm. In some embodiments of the present invention, the drapability of the sized carbon fiber tow is in the range of 1.8 cm to 5.2 cm, preferably in the range of 2 cm to 6 cm, and most preferably in the range of 3 cm to 5 cm. One method of measuring the drapability of the of the sized carbon fiber may be based on the teachings of Liu et. al [J. Liu, H. Ge, J. Chen, D. Wang and H. Liu, J. Appl. Polym. Sci., 124, 864 (2012)] using the small ruler and hook arrangement for any such measurement.

As disclosed by Kibayashi et al. under the US patent application 2013/253096, the fuzz count may be expressed in terms of the number of globules or fiber breakage instances occurring within a specific predetermined length of a sized carbon fiber. The predetermined length of the sized carbon fiber tow serves as a sample or representative length to characterize the sizing quality across the sized carbon fiber tow. The predetermined unit lengths can be at least one length selected from 1 meter, 10 meters, 20 meters, 30 meters, 50 meters, 100 meters or any such predetermined length so as to express the fuzz content per unit length of the sized carbon fiber tow. For example, the predetermined unit lengths can be greater than or equal to 1 meter, for example, 1 meter to 100 meters, or 10 meters to 50 meters.

The fiber breakage or fuzz can be expressed as the fuzz count per 20 meters of the sized carbon fiber tow with each 20 meter randomly selected for manual inspection. The use of a larger predetermined length of 20 meters in accordance with the present invention as compared to a smaller unit length of 1 meter, ensures that a sufficiently large representative sample size is taken into consideration for characterizing the sized carbon fiber tow. At a larger predetermined length the measurement of the fuzz may become difficult due to handling of the sized carbon fiber tow. The fuzz count is determined by manually inspecting the sized carbon fiber tow for instances of fiber breakage or fuzz. The fuzz count of the carbon fiber tow is determined to be less than 8 counts per 20 meters, preferably less than 5 counts per 20 meters, more preferably less than 1 count per 20 meters, and most preferably zero counts per 20 meters.

The following example is presented as a specific illustration of the claimed invention. It should be understood, however, that the invention is not limited to the specific details set forth under these examples.

### EXAMPLES

### Example 1

Relationship between Surface Energy, Fuzz Count, Drapability, Spreadability at Two Different Line Speeds

Purpose: Example 1 is an embodiment of the present invention and demonstrates the production of sized carbon fiber tow using an unsized carbon fiber tow having surface energy of at least 70 mJ/m². The example section further demonstrates that the sized carbon fiber tow of the present invention has low fuzz count, excellent sizing content and spreadability when produced at high throughput line speed leading to excellent productivity.

Material used: Seven sample grades of unsized, surface treated carbon fiber with 12,000 filaments (12K) procured from Carbon Nexus, was sized using the process as disclosed in the present invention.

TABLE 1
Materials Used

Carbon Fiber samples: unsized, surface treated carbon fiber with
12000 filaments (12K) procured from Carbon Nexus
Details of sizing:
Supplier: Michelman, USA
Sizing: Hydrosize HP3-02, Nonionic phenoxy dispersion
Solid content of HP3-02 (as received from Michelman): 33.0%
For this study, Hydrosize HP3-02 sizing is diluted with DM water
to a solid content: 1.25%.

Process/Procedure: The following process was practiced for the purposes of this example—a) an unsized carbon fiber tow having a surface energy of at least 70 mJ/m² was spread using a spreader unit to form spread carbon fibers, over a spreader unit at a throughput line speed of 5 meter/minute and forming spread carbon fibers b) the spread carbon fibers were sized a sizing bath at a throughput line speed of 5 meter/minute and formed the sized carbon fibers c) the sized carbon fibers were subsequently dried to form the sized carbon fiber tow. The sized carbon fiber tow obtained at 1 meter/min was used as a control to analyze and contrast the results obtained from using high throughput line speed of 5 meter/min. Carbon fibers having surface energy less than 70 mJ/m² was used as control for the purposes of this example.

Results: The unsized carbon fibers having different surface energy were analyzed for their spreadability, fuzz count, sizing content and drapability when processed at two different throughput line speed of 5 meter/min and 1 meter/min. The observations are tabulated in the table below:

TABLE 2
Data for fuzz content observed on the sized
fiber at line speeds of 5 m/min and lm/min

| | | | | Fuzz | | |
|---|---|---|---|---|---|---|
| | Line | Surface | | count in | Sizing | |
| Batch | speed | Energy | Spreadability | counts for | content on | Drapability |
| Code | (m/min) | (mJ/m²) | (%) | 20 m fiber | fiber (%) | (cm) |
| Sample 1 | 5 | 70.49 | 200 | 3 | 0.69 | 3 |
| Control 1a | 1 | 70.49 | 150 | 1 | 0.45 | 6 |
| Sample 2 | 5 | 72.19 | 160 | 6 | 0.73 | 3 |
| Control 2a | 1 | 72.19 | 100 | 2 | 0.32 | 9 |
| Sample 3 | 5 | 72.65 | 200 | 1 | 0.74 | 5 |
| Control 3a | 1 | 72.65 | 100 | 1 | 0.34 | 5 |
| Sample 4 | 5 | 73.23 | 200 | 0 | 0.76 | 4 |
| Control 4a | 1 | 73.23 | 140 | 0 | 0.23 | 5.5 |
| Sample 5 | 5 | 75.72 | 180 | 0 | 0.81 | 5 |
| Control 5a | 1 | 75.72 | 150 | 0 | 0.55 | 5.5 |
| Control 6 | 5 | 66.98 | 200 | 15 | 0.78 | 4.5 |
| Control 6a | 1 | 66.98 | 187 | 8 | 0.65 | 10 |
| Control 7 | 5 | 68.14 | 160 | 8 | 0.92 | 3.5 |
| Control 7a | 1 | 68.14 | 150 | 1 | 0.75 | 10 |

From Table 2, it is evident that the sized carbon fiber tow prepared at high line speeds of 5 meter/min produced sized carbon fiber tow having low fuzz count along with excellent sizing content and drapability. Further, the use of high line speed in the present embodiment of the invention compared to conventional line speeds usually of around 1-2 meter/min, ensures better productivity and process economics for the current inventive process.

Further, it was observed that at surface energy greater than 70 mJ/m²the fuzz generated was low even when the carbon fibers were drawn at a high throughput line speed of 5 meter/min. At surface energy between 73 mJ/m² and 76 mJ/m²the fuzz count was zero. As observed from the results under Table 2, the sizing content of the sized carbon fiber tow was sufficiently high as desired without compromising on the drapability of the sized carbon fiber tow.

### Example 2

Relationship between Surface Energy, Drapability, Spreadability at Various Throughput Sizing Line Speed at Zero Fuzz Count

Purpose: Example 2 as an embodiment of the present invention, demonstrates that an unsized carbon fiber tow having surface energy between 73 mJ/m² and 76 mJ/m² when sized at high throughput line speeds of 3,5,6,8 meter/min the fuzz count remains low with excellent sizing content and low drapability. The high throughput speeds also ensures excellent productivity and process economics.

TABLE 3
Material used: The following materials were
used for the purposes of this example

Carbon Fiber samples: unsized,
surface treated carbon fiber with 12000 filaments (12K)
procured from Carbon Nexus
Details of sizing:
Supplier: Michelman, USA
Sizing: Hydrosize HP3-02, Nonionic phenoxy dispersion
Solid content of HP3-02 (as received from Michelman): 33.0%
For this study, Hydrosize HP3-02 sizing is diluted with DM water
to a solid content: 1.25%.
Carbon Fiber 4 is an unsized carbon fiber sized from a
carbon fiber having a surface energy of 75.72 mJ/m²
Carbon Fiber 5 is an unsized carbon fiber sized from a
carbon fiber having a surface energy of 73.23 mJ/m²

Process/Procedure: The process of sizing the unsized carbon fiber tow was same as described under Example 1.

Results: The results obtained from the experiments conducted for the purposes of Example 2, is tabulated below. As can be observed even at various throughput line speeds the fuzz generated for the sized carbon fiber tow was low with excellent sizing content and drapability. The low fuzz count of the sized carbon fiber tow even when sized at high line speed would ensure that the sized carbon fiber tow would have excellent commercial acceptability while being produced at high productivity rate.

TABLE 4
Data for spreadability, fuzz generation and sizing content of Sample #4 and
Sample #5 at various line speeds after the sizing operation

| | | | | | | Fuzz count in |
|---|---|---|---|---|---|---|
| | Line | | Surface | Sizing | | the sized fiber |
| Batch | speed | Spreadability | Energy | content on | Drapability | for 20 m |
| Code | (m/min) | (%) | (mJ/m²) | fiber (%) | (cm) | (number) |
| Sample 5 | 3 | 160 | 75.72 | 0.63 | 5 | 0 |
| Sample 5 | 5 | 180 | 75.72 | 0.81 | 5 | 0 |
| Sample 5 | 6 | 200 | 75.72 | 1.02 | 3 | 0 |
| Sample 5 | 8 | 180 | 75.72 | 0.92 | 3.5 | 0 |
| Sample 4 | 3 | 180 | 73.23 | 0.45 | 4 | 0 |
| Sample 4 | 5 | 200 | 73.23 | 0.76 | 4 | 0 |
| Sample 4 | 6 | 200 | 73.23 | 0.85 | 3 | 0 |
| Sample 4 | 8 | 180 | 73.23 | 0.81 | 4 | 0 |

Set forth below are some Aspects of the carbon fiber tow, methods of making the tow, and articles made from the tow.

Aspect 1: A sized carbon fiber tow, comprising: an unsized carbon fiber tow sized with a sizing agent; wherein the sized carbon fiber tow has: a) a fuzz count of less than 8 counts/20 meters; b) a sizing content of at least 0.4 wt % of the unsized carbon fiber tow; and c) drapability less than 5.5 cm.

Aspect 2: The sized carbon fiber tow of Aspect 1, wherein the sized carbon fiber tow has a fuzz count of less than 1 count /20 meters, preferably a fuzz count of zero counts/20 meters.

Aspect 3: The sized carbon fiber tow of any of the preceding aspects, wherein the unsized carbon fiber tow has a surface energy of at least 70 mJ/m², preferably 71 mJ/m²to 80 mJ/m², or 72 mJ/m²to 76 mJ/m².

Aspect 4: The sized carbon fiber tow of any of the preceding aspects, wherein the sized carbon fiber tow has a sizing content in a range of 0.43% by weight to 1.2% by weight of the unsized carbon fiber tow, preferably 0.6% by weight to 0.9% by weight of the unsized carbon fiber tow.

Aspect 5: The sized carbon fiber tow of any of the preceding aspects, wherein the sizing agent is selected from a group consisting of polyurethane, polypropylene, polyethylene, polycarbonate, polyetherimide, siloxane resins, polyketones, polysulfone, polyethersulfone, polyetheretherketone, polyetherketoneketone, polyphenylenesulfide, polyacrylates, polyvinylacetates, polyamide, polyesters, polyetherimide, polyamines, polyimides, epoxy resins, phenoxy resins, melamine resins, urea resins, polyamideimides, polyethersulfones, polyetheretherketones, polyetherketoneketones, polyphenylenesulfides and combinations thereof.

Aspect 6: The sized carbon fiber tow of any of the preceding aspects, wherein the sizing agent is phenoxy resin.

Aspect 7: The sized carbon fiber tow of any of the preceding aspects, has a drapability in a range of 1.8 cm to 5.2 cm.

Aspect 8: A method of preparing a sized carbon fiber tow, comprising: spreading an unsized carbon fiber tow having a surface energy of at least 70 mJ/m², over a spreader unit at a throughput line speed of at least 3 meter/minute and forming spread carbon fibers; sizing the spread carbon fibers in a sizing bath at a throughput line speed of at least 3 meter/minute and forming sized carbon fibers; and drying the sized carbon fibers and forming the sized carbon fiber tow.

Aspect 9: The method of Aspect 8, wherein the method further comprises unspooling the unsized carbon fiber tow from a bobbin.

Aspect 10: The method of Aspect 8, wherein the unsized carbon fiber tow is used directly from a pre-sizing treatment unit without winding or unspooling the unsized carbon fiber tow.

Aspect 11: The method of any one of Aspects 8-10, wherein the method further comprises winding the sized carbon fiber tow into a spool for further processing.

Aspect 12: The method of any one of Aspects 8-11, wherein the sized carbon fibers are dried at a temperature range of 105° C. to 260° C.

Aspect 13: The method of any one of Aspects 8-12, wherein the throughput line speed is at a range of 3.5 meter/minute to 10 meter/minute.

Aspect 14: The method of any one of Aspects 8-13, wherein the throughput line speed is at a range of 4 meters/minute to 8 meter/minute.

Aspect 15: The method of any one of Aspects 8-13, further comprising passing the sized carbon fibers through a nip roller (e.g., to squeeze out any excess sizing agent) before drying.

Aspect 16: The sized carbon fiber tow of any one of Aspects 8-15, having a fuzz count of less than 8 counts/20 meters.

Aspect 17: The use of the sized carbon fiber tow of Aspect 16 in an article.

Definitions: The following includes definitions of various terms and phrases used throughout this specification.

As used in the specification and the appended claims, the singular forms “a,” “an,” and “the” include plural referents unless the context clearly dictates otherwise.

The term “about” is defined as being close to as understood by one of ordinary skill in the art. In one non-limiting embodiment, the terms are defined to be within 10%, preferably within 5%, more preferably within 1%, and most preferably within 0.5% of the reported value.

The term “carbon filament” means individual thread or strands of fiber made of carbon.

The term “composite” means a product comprising a polymeric resin matrix or a substrate having reinforcing fibers such as carbon fibers dispersed or impregnated in the polymeric matrix.

The term “tow” means a bundle of carbon fibers comprising several thousand individual carbon fiber filaments.

The term “throughput line speed” means the speed at which the bobbins or spool or rollers, are rotated or operated at for drawing unsized carbon fiber tow comprising carbon fiber filaments for sizing or spreading.

The term “high throughput line speed” means a throughput line speed of at least 3 meter/minute.

The term “spreadability” means the extent or the degree of separation of individual carbon fiber filaments from each other after passing the unsized carbon fiber tow through a spreader unit.

The term “drapability” or “drape” means flexibility or the bending ability of the sized carbon fiber tow over a bobbin or a roller for further processing.

The term “fuzz” means fiber breakage or more specifically carbon fiber filaments, which get broken as a result of mechanical abrasion during processing to generate stray carbon fiber filaments or threads or globules on the surface of carbon fiber tow. The fuzz generated is quantified using the unit of “fuzz count per 20 meter” of the sized carbon fiber tow when the sized carbon fiber tow is manually inspected.

The term “substantially free of fuzz” means fiber breakage count, which is either absent or is present on the surface of sized carbon fiber tow at an amount less than 8 counts/20 meters when observed or inspected manually.

The term “sized carbon fiber” means a polymeric coating on the surface of carbon fibers produced after dip-coating the unsized carbon fiber tow in a sizing bath containing sizing agent.

The term “sized” means the polymeric coating on the surface of unsized carbon fiber tow.

The term “sizing content” means amount of sizing adhered to or coated on carbon fiber surface after passing through a sizing bath.

The term “surface energy” means the surface tension value of the carbon fiber surface, which is proportional to the polar or oxygen-based functional groups generated through electrochemical surface treatment of the unsized carbon fiber tow.

The term “bobbin” or “spool” means individual package comprising a carbon fiber roving which is wound on to a core /support.

The term “wrapping angle” means the distance in degrees that a tensioned carbon fiber tow contacts the roller pins.

The term “high surface energy” means a carbon fiber tow or an individual carbon fiber surface having a surface energy value of at least 70 mJ/m².

1. A sized carbon fiber tow, comprising:
an unsized carbon fiber tow sized with a sizing agent; wherein the sized carbon fiber tow has:
a) a fuzz count of less than 8 counts/20 meters as determined by manual inspection;
b) a sizing content of at least 0.4 wt % of the unsized carbon fiber tow;
c) drapability less than 5.5 cm as determined in accordance with J. Liu, H. Ge, J. Chen, D. Wang and H. Liu, J. Appl. Polym. Sci., 124, 864 (2012), using a small ruler and hook arrangement; and
wherein the unsized carbon fiber tow has a surface energy of at least 70 mJ/m², wherein the surface energy is proportional to polar or oxygen-based functional groups generated through electrochemical surface treatment of the unsized carbon fiber tow.

2. The sized carbon fiber tow of claim 1, wherein the sized carbon fiber tow has a fuzz count of less than 1 count /20 meters.

3. The sized carbon fiber tow of claim 1, wherein the surface energy is 71 mJ/m².

4. The sized carbon fiber tow of claim 1, wherein the sized carbon fiber tow has a sizing content in a range of 0.43% by weight to 1.2% by weight of the unsized carbon fiber tow.

5. The sized carbon fiber tow of claim 1, wherein the sizing agent is polyurethane, polypropylene, polyethylene, polycarbonate, polyetherimide, siloxane resin, polyketone, polysulfone, polyethersulfone, polyetheretherketone, polyetherketoneketone, polyphenylenesulfide, polyacrylate, polyvinylacetate, polyamide, polyester, polyetherimide, polyamines, polyimides, epoxy resins, phenoxy resin, melamine resin, urea resin, polyamideimide, combination thereof.

6. The sized carbon fiber tow of claim 1, wherein the sizing agent is phenoxy resin.

7. The sized carbon fiber tow of claim 1, having a drapability in a range of 1.8 cm to 5.2 cm.

8. A method of preparing a sized carbon fiber tow, comprising:
a) spreading an unsized carbon fiber tow having a surface energy of at least 70 mJ/m², over a spreader unit at a throughput line speed of at least 3 meter/minute and forming spread carbon fibers;
b) sizing the spread carbon fibers in a sizing bath at a throughput line speed of at least 3 meter/minute and forming sized carbon fibers; and
c) drying the sized carbon fibers and forming the sized carbon fiber tow.

9. The method of claim 8, wherein the method further comprises unspooling the unsized carbon fiber tow from a bobbin.

10. The method of claim 8, wherein the unsized carbon fiber tow is used directly from a pre-sizing treatment unit without winding or unspooling the unsized carbon fiber tow.

11. The method of claim 8, wherein the method further comprises winding the sized carbon fiber tow into a spool for further processing.

12. The method of claim 8, wherein the sized carbon fibers are dried at a temperature range of 105° C. to 260° C.

13. The method of claim 8, wherein the throughput line speed is at a range of 3.5 meter/minute to 10 meter/minute.

14. The method of claim 8, wherein the throughput line speed is at a range of 4 meters/minute to 8 meter/minute.

15. The sized carbon fiber tow of claim 8, having a fuzz count of less than 8 counts/20 meters.

16. An article comprising the sized carbon fiber tow of claim 1.
